(19) United States
(12) Patent Application Publication
(10) Pub. No.: US 2004/0076073 A1
(43) Pub. Date: Apr. 22, 2004

(54) Treated material stirring apparatus

(76) Inventors: Yaoguang Yao, Kyoto (JP); Kaoru Fujimori, Shiga (JP); Motonobu Fujimori, Shiga (JP); Tadao Tishiro, Shiga (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/468,006

(22) PCT Filed: Feb. 19, 2002
(86) PCT No.: PCT/JP02/01414

(30) Foreign Application Priority Data
Feb. 21, 2001 (JP) 2001-45129

(51) Int. Cl. B29B 7/46

(52) U.S. Cl. 366/83; 366/100; 366/295

(57) ABSTRACT

A treatment material agitating and processing apparatus comprises a casing (1) having a supply inlet (13) and a delivery outlet (12) provided therein, an agitator (2) of a screw form arranged to extend lengthwise in the casing (1), and a driving mechanism (3) for driving the agitator (2) to rotate in the casing (1). The agitator (2) repeats a given pattern of its forward and backward rotating actions thus to agitate and convey the treatment material (A) throughout the casing (1). Accordingly, while the duration of the treatment material (A) staying in the casing is favorably determined by the pattern of the forward and backward rotating actions of the agitator (2), the agitated effect of the treatment material (A) can be preset to a desired level by adjusting the rotating speed of the agitator (2).

### FIELD OF THE INVENTION

The present invention relates to a treatment material agitating and processing apparatus for agitating and forwarding a treatment material for subjecting to mixing, kneading, drying, heating, melting, reacting, reaction forming, extruding, reaction extruding, or other process.

### BACKGROUND OF THE INVENTION

A treatment material agitating and processing apparatus with both functions of agitating and forwarding is well known for subjecting materials to mixing, kneading, drying, heating, melting, reacting, reaction forming, extruding, reaction extruding, or other process. Such a conventional treatment material agitating and processing apparatus comprises a casing having a supply inlet and a delivery outlet provided therein for input and output of a treatment material, an agitator consisting mainly of an agitator shaft and a agitating blade provided on the outer surface of the agitator shaft and arranged to extend lengthwise in the casing, and a driving mechanism for driving the agitator to rotate.

The convention treatment material processing and agitating apparatus allows the treatment material to be agitated and conveyed throughout the casing by the rotating action in the forward direction of the agitator and then subjected, during or after the agitation, to a particular mode of the processing action such as mixing, kneading, drying, heating, melting, reacting, reaction forming, extruding, or reactive extruding. For example, the treatment material introduced into the casing of an extruder, that acts as a conventional treatment material agitating and processing apparatus, is agitated and conveyed by the action of the agitator. During the agitation, the treatment material is heated and compressed to a plastic form, and extruded from a dice provided at the front end of the casing by the propelling action of the agitator.

Accordingly, as the treatment material is agitated by the action of the agitator, it can more effectively be subjected to a desired mode of the processing action than with no use of the agitation.

However, the agitator in the conventional treatment material agitating and processing apparatus is driven for rotating in the forward direction to agitate and convey the treatment material. This may hardly provide common improvement in both the staying duration in the casing and the agitated effect of the treatment material.

When the rotation of the agitator is speeded up for improving the agitated effect, the traveling speed of the treatment material throughout the casing increases. Accordingly, as the treatment material is decreased in the staying duration in the casing, its processing will be insufficient.

On the other hand, when the rotation of the agitator is slowed down for increasing the duration of the treatment material staying in the casing, the treatment material is conveyed in a settled form (or in a laminar flow when the material is a fluid) by the retarding action of the agitator 2′ throughout the casing 1′ as shown in FIG. 8, therefore its agitating will be insufficient. Particularly when the treatment material is a highly viscous liquid or a powder form, it may adhere to and rotate together with the agitator. In the conventional treatment material agitating and processing apparatus with no self-cleaning function, the treatment material may easily be bonded to the agitator.

It is true in the conventional treatment material agitating and processing apparatus that the treatment material can stay longer in the casing and its agitated effect can be improved when the length of the casing is increased and the rotating speed of the agitator is speeded up. This will however increase the size and cost of the apparatus.

### SUMMARY OF THE INVENTION

The present invention has been developed in view of the above aspects and its object is to provide a treatment material agitating and processing apparatus which can optimize both the staying duration in the casing and the agitated effect of the treatment material without trading off the other while minimizing the overall size and the cost.

For achievement of the above object of the present invention, a treatment material agitating and processing apparatus is provided comprising a casing having a supply inlet and a delivery outlet provided therein, one or more agitators, each agitator consisting mainly of an agitator shaft and an agitating blade provided on the outer surface of the agitator shaft and arranged to extend lengthwise in the casing, and a driving mechanism for driving the agitators to rotate in the casing. In action, the agitators repeat a given pattern of their forward and backward rotating actions thus to agitate and convey the treatment material throughout the casing.

More particularly, this allows the treatment material to be agitated and moved forward and backward throughout the casing by the rotation in the forward and backward directions of the agitators before finally advanced from the supply inlet to the delivery outlet of the casing. As the traveling distance of the treatment material in the casing is actually longer than the physical length of the casing, the duration of the treatment material staying in the casing will increase.

The staying duration of the treatment material depends on not only the rotating speed of the agitators but also a pattern of the rotating action in the forward and backward directions of the agitators and can hence be independent from the rotating speed of the agitators. The treatment material agitating and processing apparatus is hence capable of arbitrarily presetting the duration of the treatment material staying in the casing through adjusting the rotation alternatively in the forward and backward directions of the agitators and simultaneously determining the agitated effect of the treatment material through adjusting the rotating speed of the agitators. Accordingly, both the duration of staying in the casing and the agitated effect of the treatment material can be maintained at desired settings without trading off the other.

As the treatment material is pushed and pulled by the rotation alternately in the forward and backward directions of the agitators, it can never stay at particular locations or turn to a settled form hence being prevented from rotating together with the agitators. Also, as the treatment material is irregularly thrown by the alternate rotating actions of the agitators, it can be agitated more steadily.

Moreover, as the treatment material agitating and processing apparatus needs not to be lengthened in the casing and the agitators, its size and cost can successfully be reduced.

### BRIEF DESCRIPTION OF THE DRAWINGS

FIG. 1 is a schematic view of a treatment material agitating and processing apparatus showing one embodiment of the present invention;

FIG. 2 is an enlarged cross sectional view of a primary part of the treatment material agitating and processing apparatus shown in FIG. 1;

FIG. 3 illustrates a pattern of movements of the treatment material;

FIG. 4 illustrates a profile of the relationship between location and time in one cycle action of the treatment material;

FIG. 5 is a schematic view of a treatment material agitating and processing apparatus showing a third embodiment of the present invention;

FIG. 6 is a schematic view of a treatment material agitating and processing apparatus showing a fourth embodiment of the present invention;

FIG. 7 is an enlarged view of a primary part of a treatment material agitating and processing apparatus showing a fifth embodiment of the present invention; and

FIG. 8 is an enlarged view of a primary part of a conventional treatment material agitating and processing apparatus.

### BEST MODES FOR EMBODYING THE INVENTION

(Embodiment 1)

A treatment material agitating and processing apparatus according to Embodiment 1 of the present invention will be described.

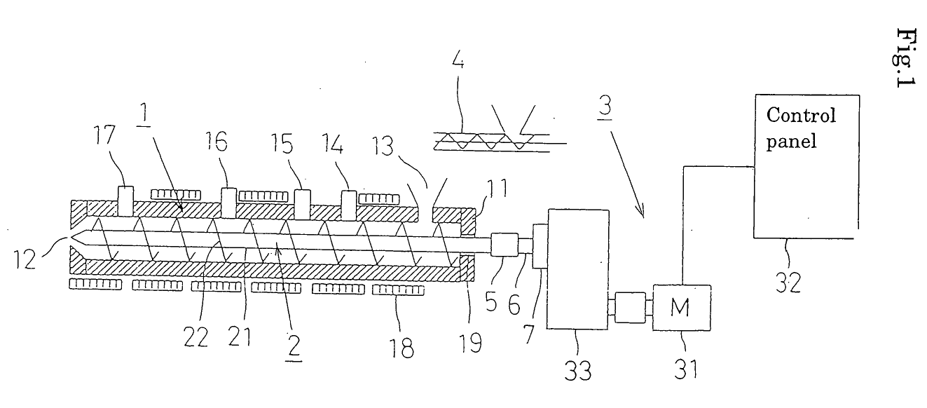

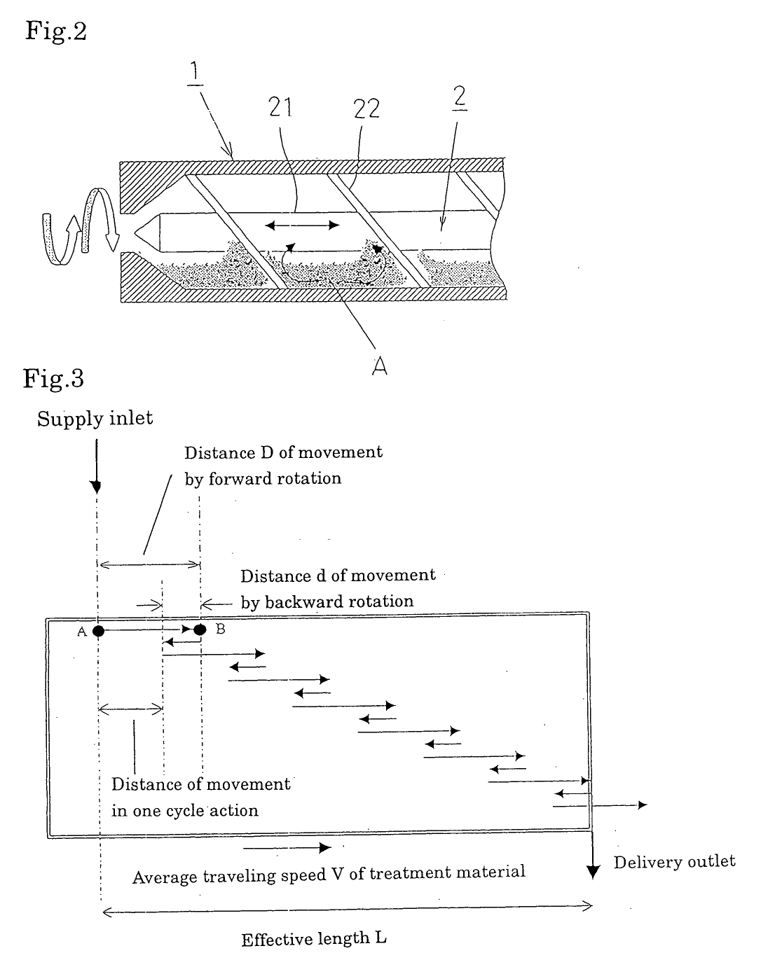

Shown in FIG. 1 is the treatment material agitating and processing apparatus comprising a cylindrical casing 1, a screw agitator 2 provided lengthwise in the casing 1, and a driving mechanism 3 for driving the agitator 2.

The casing 1 has an end plate 11 provided at the upstream end thereof for enclosure and a delivery outlet 12 provided in the downstream end thereof. Also, a supply inlet 13, a liquid inlet 14, a vent 15, a sub supply inlet 16, and a vacuum vent 17 for removing water and non-reacted impurities with the use of vacuum are provided at given intervals from the upstream end to the downstream end in the casing 1. A treatment material A, a liquid, and a sub treatment material A are introduced from the supply inlet 13, the liquid inlet 14, and the sub supply inlet 16 respectively. The vent 15 allows air to escape as necessary. The vacuum vent 17 is used for removal of water and non-reacted impurities from the casing 1. Moreover, a temperature control mechanism 18 is provided on the outer side of the casing 1 for heating and cooling the treatment material A in the casing 1.

A supply device 4 such as a material feeder or a supply pump is provided above the supply inlet 13 of the casing 1. The action of the supply device 4 for feeding the treatment material A may be a common steady feeding method or an intermittent feeding method in which the feeding temporally pauses when the agitator 2 is temporarily paused or rotated in the backward direction before rotated forward. When the steady feeding method is used, the treatment material A is moved backward from the supply inlet 13 towards the upstream end by a backward rotating action of the agitator 2 and its receiving space is preferably provided at the upstream side of the supply inlet 13 in the casing 1.

The agitator 2 consists mainly of an agitator shaft 21 and a spiral agitating blade 22 mounted to the outer surface of the agitator shaft 21. The agitator shaft 21 is installed lengthwise of the casing 1 with its distal end facing the delivery output 12 of the casing 1 and its proximal end extending outwardly in a sealing member 19 across the center of the end plate 11 of the casing 1 while the outer edge of the agitating blade 22 stays in direct contact with the inner surface of the casing 1. The sealing member 19 may be of a known journal sealing type for use in an extruder or a reactor. Preferably, the sealing member 19 is of a double sealing type because the treatment material A is urged against the end plate 11 by the backward rotating action of the agitator 2.

As the proximal end of its agitator shaft 21 is driving connected to the driving mechanism 3, the agitator 2 can be rotated alternately in the forward and backward directions in the casing 1 by the action of the driving mechanism 3.

More specifically, the agitator 2 is driven by the driving mechanism 3 to repeat one action cycle of rotation in the forward direction, pause, rotation in the backward direction, and pause (the number of forward rotations being greater than the number of backward rotations). As the agitator 2 repeats the rotating action cycle, the treatment material A is conveyed in a cyclic action of forward movement by a distance D, stop, backward movement by a distance d, and stop throughout the casing 1, as shown in FIG. 3. Accordingly, the treatment material A is moved from the supply inlet 13 to the delivery outlet 12 of the casing 1 at an average traveling speed V.

The average traveling speed V of the treatment material A is obtained from Equation (5).

V=kPN(Tf−Tr)/(Tf+Tr+2Ts) (5)

where k is the coefficient determined depending on the shape of the agitating blade 22, the physical properties of the treatment material A, and the filling rate (0<k≦1), P is the pitch on the agitating blade 22, N is the rotating speed of the agitator 2, Tf is the duration of forward rotation of the agitator 2, Tr is the duration of backward rotation of the agitator 2, and Ts is the duration of the agitator 2 pausing between the forward and backward rotating actions. No matter what a rotating speed N of the agitator 2 is preferred for obtaining a satisfactory agitating effect, the average traveling speed V of the material A can be adjusted to the optimum by modifying the duration of forward and backward rotating actions of the agitator 2. As the duration of the treatment material A remaining in the casing 1 is determined by the average traveling speed V, it depends on the forward and backward rotating actions of the agitator 2 as well as the rotating speed. In other words, the duration of the treatment material A remaining in the casing 1 is not completely dependent on the rotating speed of the agitator 2. Accordingly, the duration of the treatment material A remaining in the casing 1 can be set to a desired length of time by determining a combination of the forward rotation and the backward rotation of the agitator 2. Also, the agitation of the treatment material A can be set to a desired level by adjusting the rotating speed of the agitator 2. As the result, both the agitated effect and the duration of the treatment material A remaining in the casing 1 can be optimized without trading off the other.

As the treatment material A is driven in alternate directions by the forward and backward rotating actions of the agitator 2, it hardly remains at one particular location or turns to an undesired settled form and can thus be protected from rotating together with the agitating blade 22 of the agitator 2. Also, as the treatment material A is irregularly thrown in turbulence by the alternate rotating actions of the agitator 2, it can be agitated more steadily.

Moreover, as its overall length is minimized, the treatment material agitating and processing apparatus can be reduced in both the size and the cost.

The driving mechanism 3 consists mainly of a driving motor 31 for driving the agitator 2 to rotate, a control panel 32 for controlling the speed, direction, and duration of the revolution of the driving motor 31, and a speed reducer 33 for adjusting the revolution speed of the motor 31.

The control panel 32 includes a speed controller, a reverse controller, a timer, and an accelerator for controlling the acceleration or deceleration of the revolution of the driving motor 31 so as to adjust its speed, direction, and duration to desired settings. As its actions including the forward and backward rotating actions and the switching between the forward and backward rotations as well as their duration of time are automatically controlled with the control panel 32, the agitator 2 can be operated in a desired pattern suited for a particular mode of the processing action. The control panel 32 may employ either an electrical system for controlling the phase and direction of a current supplied to the driving motor 31 to determine a desired action of the driving motor 31 or a mechanical system including toothed wheels and a clutch for controlling not the motor 31 but the rotating action of the agitator 2 mechanically with the use of a specifically designed program. The power source in the driving mechanism 3 is not limited to the motor 31 but may be any other driving system such as an oil hydraulic system.

The speed reducer 33 is linked via a coupling mechanism 5, a driving shaft 6, and a bearing assembly 7 to the agitator shaft 21 of the agitator 2 for adjusting the revolution speed of the driving motor 31. The coupling mechanism 5 is provided for detachably coupling between the agitator shaft 21 and the driving shaft 6. This allows the agitator 2 to be replaced with a new one or dislocated forward or backward for correct positioning without dismounting its bearings. The bearing assembly 7 may preferably be high in the axial retaining strength for preventing the agitator shaft 21 from being dislocated forward during the backward rotation of the agitator 2.

The action of the treatment material agitating and processing apparatus of this embodiment will now be described in more detail.

When a desired operating program is set by the control panel 32, it actuates the driving motor 31 for repeatedly carrying out a cycle of forward revolution, pause, backward revolution, and pause (the number of forward revolutions being greater than the number of backward revolutions). The revolution of the driving motor 31 is adjusted with the speed reducer 33 and then transmitted via the bearing assembly 7, the driving shaft 6, and the coupling mechanism 5 to the agitator 2.

As is driven by the driving mechanism 3, the agitator 2 repeats its action cycle of rotation in the forward direction, pause, rotation in the backward direction, and pause (the number of forward rotations being greater than the number of backward rotations).

Then, the treatment material A is introduced from the supply inlet 13 into the casing 1 by the action of the supply device 4 and conveyed from the supply inlet 13 to the delivery outlet 12 in the casing at the average traveling speed V through repeating its cyclic action of forward movement by the distance D, stop, backward movement by the distance d, and stop.

While the treatment material A being conveyed from the supply inlet 13 to the delivery output 12, it is mixed with a sub treatment material introduced from the sub supply inlet 16 and a liquid introduced from the liquid inlet 14 and agitated forward and backward by the agitator 2 rotating alternately in the forward and backward directions. As the treatment material A while remaining not rotated together with the agitating blade 22 is irregularly thrown in turbulence by the alternate rotating actions of the agitator 2, it can be agitated more steadily.

The action cycle of the agitator 2 to be repeated is not limited to that in the embodiment of rotation in the forward direction, pause, rotation in the backward direction, and pause (the number of forward rotations being greater than the number of backward rotations) but may be any appropriate cyclic action. For example, the action cycle may involve a cyclic pattern of rotation in the forward direction, pause, rotation in the forward direction, pause, rotation in the backward direction, and pause or another cyclic pattern of rotation in the forward direction, pause, rotation in the backward direction, pause, rotation in the backward direction, and pause. Also, the cycle action may be a cyclic pattern of rotation in the forward direction, rotation in the backward direction, rotation in the forward direction, and rotation in the backward direction which includes no pause between any two, forward and backward, directional rotating actions. Furthermore, the action cycle may be shifted from one cyclic pattern to another during the operation. It is essential for the treatment material being conveyed from the supply inlet 13 to the delivery outlet 12 while being agitated by forward and backward movements to have the number of forward rotations of the agitator 2 arranged greater than the number of backward rotations.

While the agitator 2 is driven for having the number of forward rotations greater than the number of backward rotations during the action cycle, its cyclic action may include a step of having the number of forward rotations not greater than the number of backward rotations.

Although the casing 1 accommodates the single agitator 2 extending lengthwise in the embodiment, it may contain two or more of the agitators 2 extending parallelly. The agitators 2 may also be driven separately or simultaneously in synchronization. Also, the agitators 2 may be identical or different in the direction of the rotating action. Moreover, the agitators 2 may be meshed with each other in entire, partial, or non tooth engagement.

The agitator 2 is not limited to the shape of the embodiment but may arbitrarily be modified depending on the treatment material A and the mode of processing action to be carried out. For example, the agitator 2 can be shaped of a type selected from full flight screw, ribbon blade, annular blade, strip blade, cut screw, tapered screw, back screw, and kneading screw. The agitator 2 may have such a shape as to agitate and carry the treatment material A forward.

The action of the agitator 2 is not limited to the agitation in the embodiment but may include mixing, kneading, milling, compressing, melting, dissolving, reducing, averaging, or reacting.

(Embodiment 2)

Another treatment material agitating and processing apparatus according to Embodiment 2 of the present invention will be described.

The treatment material agitating and processing apparatus of Embodiment 2 is substantially identical in the construction to that of Embodiment 1. The duration Ts of the agitator 2 pausing between the forward and backward rotating actions is expressed by:

0≦Ts<t+2 (1)

where t is the length of time from the stop of the driving mechanism to the stop of the agitator.

The pausing duration Ts of the agitator 2 is predetermined for minimizing declination in the agitating efficiency of the treatment material A during the pausing of the agitator 2 and preventing damage to the driving mechanism due to an abrupt change in the direction of the revolution of the driving motor 31. For improving the agitating efficiency and eliminating damage to the driving mechanism, the pausing duration Ts is highly desirable when t<Ts<t+0.5 (1′). The values of “2” and “0.5” in Equations (1) and (1′) are read in seconds.

The duration Tf of the agitator 2 rotating in the forward direction is expressed by:

0<Tf<0.2×(60p)/(Nk) (2)

where p is the number of pitches on the agitating blade, N is the speed of the rotation of the agitator 2, and k is a coefficient (0<k≦1).

The duration Tf of the forward rotation of the agitator 2 is predetermined as expressed by Equation (2) for preventing different types of the treatment material A, which are introduced at discrete timings, from being mixed together and ensuring consistent in the processing action.

If the moving distance D of the treatment material A by the rotation in the forward direction of the agitator 2 is lengthened during the periodical forward and backward motion in the casing 1 as shown in FIG. 3, the probability of mixing between different types of the treatment material A will increase. Accordingly, different types of the treatment material A will be varied in the duration of stay in the casing 1 and hardly be uniform in the processing effect.

It is hence desirable that the moving distance D of the treatment material A by the rotation in the forward direction of the agitator 2 remains not greater than 20% the effective length L of the casing 1.

0<D<L×0.2

Hence,

0<(k×P×N/60×Tf)<(p×P)×0.2 (21)

where k is a coefficient (0<k≦1), P is the pitch on the agitating blade 22 of the agitator 2, N is the speed of rotation of the agitator 2, Tf is the duration of the agitator 2 rotating in the forward direction, and p is the number of pitches on the agitating blade 22 of the agitator 2. Equation (2) can be determined from Equation (21).

The duration Tr of the agitator 2 rotating in the backward direction is expressed by either Equation (3) or Equation (4).

0<Tr<Tmin (3)

Tmax<Tr<Tf (4)

where Tf is the duration of forward rotation of the agitator 2 and Tmin and Tmax are the small value and the large value of the solutions Tr at kN

(Ts+Tr)(Tf−Tr)/{30p(Tf+Tr+2Ts)}=0.1 respectively.

The duration Tr of the agitator 2 rotating in the backward direction is predetermined for ensuring consistent in the processing action.

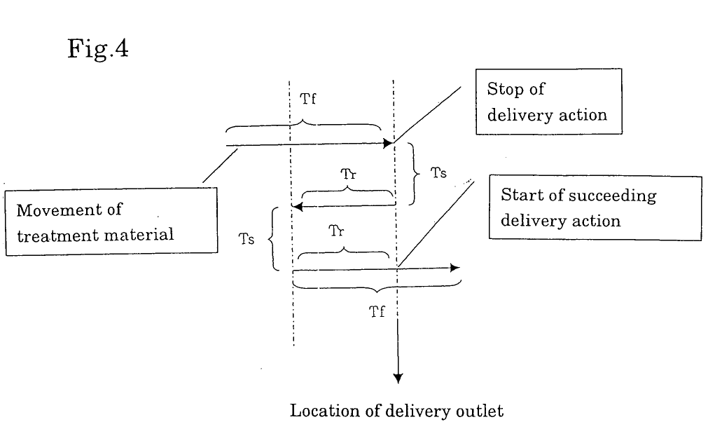

As the agitator 2 alternates the forward rotation and the backward rotation, it causes the treatment material A to be discontinuously released from the delivery outlet 12. More specifically, as shown in FIG. 4, when the agitator 2 after rotation in the forward direction is paused or shifted to the rotation in the backward direction, the delivery of the treatment material A is temporarily pauses. The delivery restarts in a midway of the succeeding rotation in the forward direction of the agitator 2. Accordingly, there is a difference in the duration of stay in the casing 1 between the present delivery and the succeeding delivery of the treatment material A. When the difference is as large as not negligible, the products of the treatment material A may be varied in the quality.

The difference ΔT in the stay of the treatment material A is expressed by:

ΔT=Ts+Tr+Ts+Tr=2(Ts+Tr) (31)

When the effective length of the casing 1 is L and the average traveling speed of the treatment material A is V, the total duration of stay of the treatment material A in the casing 1 is obtained from:

T=(60L)/V (32)

Hence, the deviation Td of the difference ΔT from the average stay duration T is calculated from:

$$\begin{matrix}Td = Δ T / T \\ = 2 ( Ts + Tr ) / \{ ( 60 L ) / V \} \\ = ( Ts + Tr ) V / ( 30 L )\end{matrix} \qquad ( 33 )$$

Using Equation (5), this is expressed by:

Td=(Ts+Tr)kPN(Tf−Tr)/{30L(Tf+Tr+2Ts)} (34)

Then, using L=P×p, Equation (34) is replaced by:

Td=kN(Ts+Tr)(Tf−Tr)/{30p(Tf+Tr+2Ts)} (35)

It is desirable for ensuring consistent in the processing action, the deviation Td is smaller than 0.1.

kN(Ts+Tr)(Tf−Tr)/{30p(Tf+Tr+2Ts)}<0.1 (36)

Equations (3) and (4) can hence be established from a combination of Equation (36) and 0<Tr<Tf.

(Embodiment 3)

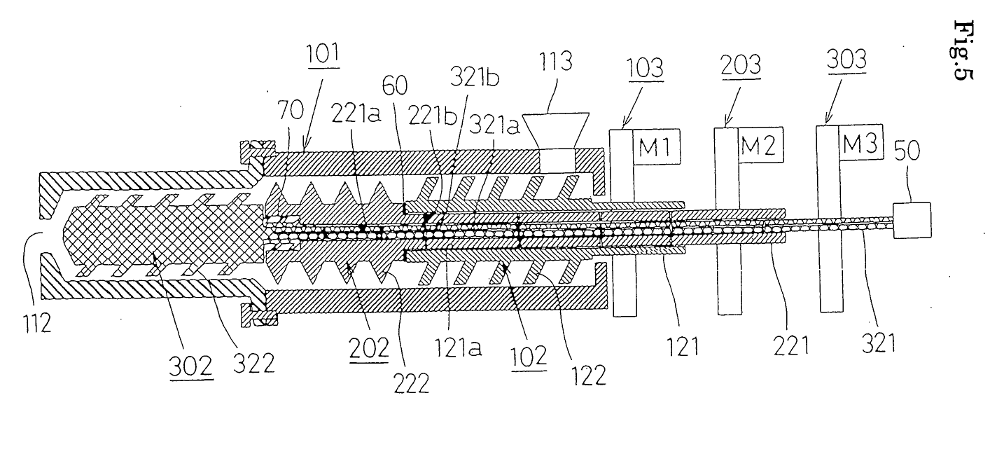

A further treatment material agitating and processing apparatus according to Embodiment 3 of the present invention will be described referring to FIG. 5.

In this embodiment, three, first, second, and third, agitators 102, 202, and 302 are axially provided in a row in a casing 101. The three agitators 102, 202, and 302 are driven by three driving mechanisms 103, 203, and 303 respectively.

The first agitator 102 consists mainly of an agitator shaft 121 and an agitating blade 122. While the agitating blade 122 remains in contact with the inner surface at the upstream end of the casing 101, the agitator shaft 121 extends across the rear end plate of the casing 101 and is linked at the proximal end to the driving mechanism 103. The driving mechanism 103 drives the agitator 102 to rotate constantly in the forward direction. This allows the treatment material A introduced into the casing 101 to be agitated and directly conveyed towards the second agitator 202 by the rotation in the forward direction of the agitator 102.

Also, the second agitator 202 consists mainly of an agitator shaft 221 and an agitating blade 222. While the agitating blade 222 remains in contact with the inner surface at the central region of the casing 101, the agitator shaft 221 extends across a through bore 121a provided lengthwise in the agitator shaft 121 of the first agitator 102 and is linked at the proximal end to the driving mechanism 203. The driving mechanism 203 drives the agitator 202 to rotate alternately in the forward and backward directions. This allows the treatment material A received from the first agitator 102 to be agitated and conveyed towards the third agitator 302 through forward and backward movements by the rotation in both the forward and backward directions of the second agitator 202.

Similarly, the third agitator 302 consists mainly of an agitator shaft 321 and an agitating blade 322. While the agitating blade 322 remains in contact with the inner surface at the downstream end region of the casing 101, the agitator shaft 321 extends across a through bore 221a provided lengthwise in the agitator shaft 221 of the second agitator 202 and is linked at the proximal end to the driving mechanism 303. The driving mechanism 303 drives the agitator 2 to rotate constantly in the forward direction. This allows the treatment material A received from the second agitator 202 to be agitated and directly conveyed towards the delivery outlet 112 of the casing 101 by the rotation in the forward direction of the third agitator 302.

The second agitator 102, which rotates alternately in the forward and backward directions, may be installed at a favorable location in the casing 1. When all the three agitators 102, 202, and 302 are arranged for rotating in both the forward and backward directions and controlled under desired conditions respectively, they can agitate the treatment material A in an optimum manner appropriated for a particular mode of the processing action.

Also, the casing 101 consists mainly of two separate parts, which are separated lengthwise and joined to each other by screws for ease of mounting and dismounting the agitators 102, 202, and 302. This allows the three agitators to be replaced with other favorable shapes depending on the properties of the treatment material A and the mode of the processing action.

The agitator shaft 321 of the third agitator 302 is connected at the far proximal end to a lubricator 50 and has a lubricant passage 321a provided therein axially extending from the lubricator 50. Also, the agitator shaft 321 has a group of branch lubricant passages 321b provided therein radially extending from the lubricant passage 321a. Equally, the agitator shaft 221 of the second agitator 202 has a group of branch lubricant passage 221b provided therein radially extending from the branch lubricant passages 321b in the third agitator 302. Accordingly, a lubricant dispatched from the lubricator 50 runs through the lubricant passage 321a and the branch lubricant passages 321b in the third agitator 302 and enters between the agitator shaft 321 of the third agitator 302 and the agitator shaft 221 of the second agitator 202 before running through the branch lubricant passages 221b in the second agitator 202 and entering between the agitator shaft 221 of the second agitator 202 and the agitator shaft 121 of the first agitator 102. As the result, frictional and resistive stresses developed between the agitator shafts 121, 221, and 321 of their respective agitators 102, 202, and 302 can successfully be declined.

Also, a sealing member 60 is provided between a step portion of the second agitator 202 and the distal end of the first agitator 102 for inhibiting the treatment material A from entering between the second agitator 20 and the first agitator 102.

Furthermore, a small thread 70 is provided on a step portion of the third agitator 302 for forcing the treatment material A outwardly as it rotates.

While the function of rotating alternately in the forward and backward directions is assigned to the second agitator 202 in this embodiment, it may also be assigned to either the first agitator 102 or the third agitator 302, or two or all the three agitators.

The number of the agitators installed in the casing 101 is not limited to three but may be two, four, or more.

(Embodiment 4)

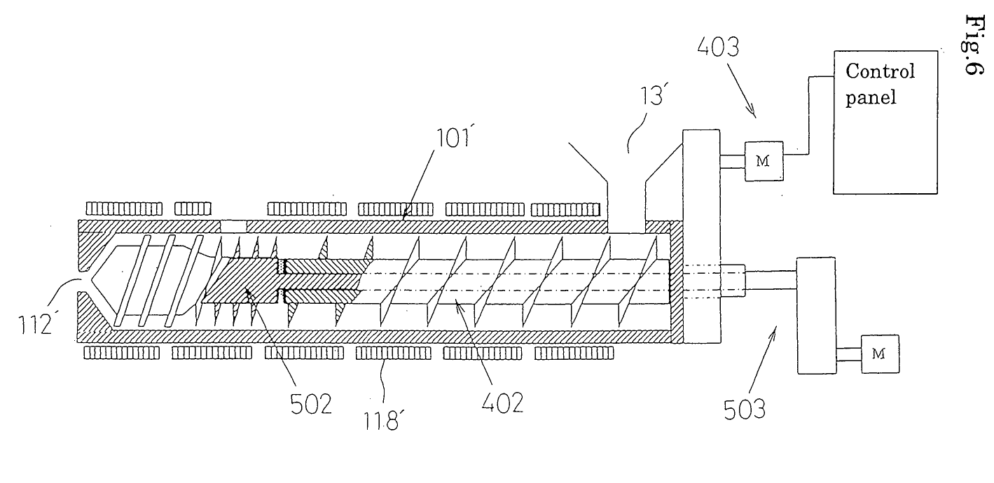

A treatment material agitating and processing apparatus according to Embodiment 4 of the present invention will be described referring to FIG. 6.

Shown in FIG. 6 is an agitator 402 which is driven by a driving motor 403 for rotating alternately in the forward and backward directions. Another agitator 502 is provided as an extruder that is driven by a driving motor 503 for rotating constantly in the forward direction.

This allows the treatment material A to be subjected to mixing, kneading, compressing, milling, heating, melting, or reacting process by the rotation alternately in the forward and backward directions of the agitator 402 and then extruded efficiently by the rotation in the forward direction of the extruding agitator 502 for continuous extrusion forming or quantitative extrusion action. Also, when its casing is modified to a shape 101′ having a deaeration region and a compression region, the apparatus allows the treatment material to be processed through deaeration region and compression region and can thus be utilized for deaeration, compression, stabilization and measuring process.

(Embodiment 5)

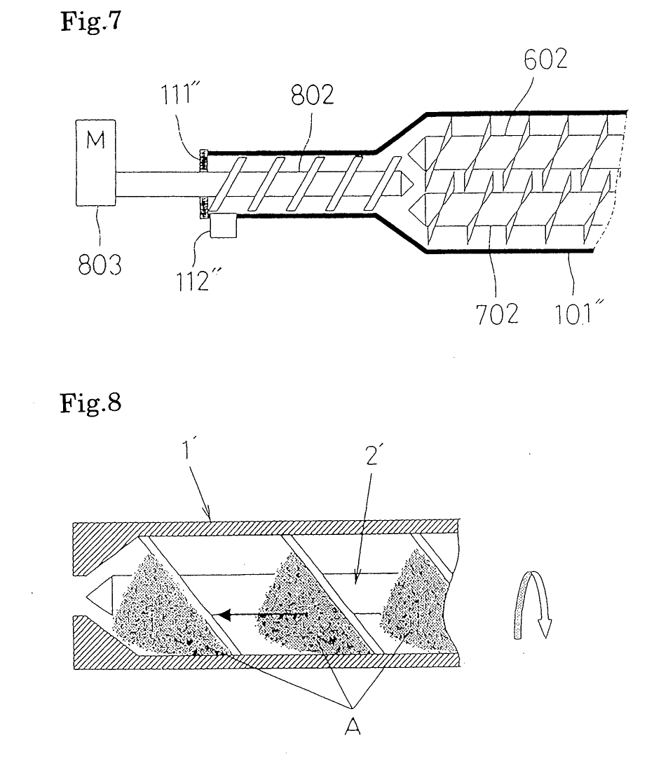

A treatment material agitating and processing apparatus according to Embodiment 5 of the present invention will be described referring to FIG. 7.

Shown in FIG. 7 are a couple of agitators 602 and 702 for rotating alternately in the forward and backward directions. An extruding agitator 802 is provided between the free end of the two agitators 602 and 702 and a delivery outlet 112″ of a casing 101″ for rotating constantly in the forward direction. The extruding agitator 802 is driven by a driving motor 803, which are not linked to the two agitators 602 and 702. The casing 101″ also has an end plate 111″ provided at the downstream end thereof.

This allows the treatment material to be subjected to mixing, kneading, compressing, milling, heating, melting, or reacting by the rotation alternately in the forward and backward directions of the two agitators 602 and 702 and then extruded efficiently by the rotation in the forward direction of the extruding agitator 802 for continuous extrusion forming or quantitative extrusion action.

The treatment material agitating and processing apparatus enables to arbitrarily preset the duration of the treatment material staying in the casing through adjusting the rotation alternatively in the forward and backward directions of the agitators and to simultaneously determine the agitated effect of the treatment material through adjusting the rotating speed of the agitators. Accordingly, both the duration of staying in the casing and the agitated effect of the treatment material can be maintained at desired settings without trading off the other.

As the treatment material is pushed and pulled by the rotation alternately in the forward and backward directions of the agitators, it can never stay at particular locations or turn to a settled form hence being prevented from rotating together with the agitators. Also, as the treatment material is irregularly thrown by the alternate rotating actions of the agitators, it can be agitated more steadily.

Moreover, as the treatment material agitating and processing apparatus needs not to be lengthened in the casing and the agitators, its size and cost can successfully be reduced.

The treatment material agitating and processing apparatus is capable of determining easily and certainly a desired pattern of the rotating action of the agitators depending on the mode of the processing action to be carried out.

The treatment material agitating and processing apparatus can prevent declination in the agitating efficiency of the treatment material which may result from the pausing action of the agitators and damage to the driving mechanism due to abrupt directional change in the revolution of the driving motor.

The treatment material agitating and processing apparatus can protect different types of the treatment material introduced at discrete timings from being mixed together, hence being uniform in the processing action.

The treatment material agitating and processing material can remain consistent in the processing action.

The treatment material agitating and processing apparatus allows the agitators to be installed at a desired location for rotating alternately in the forward and backward directions. Also, when all the agitators are arranged for rotating alternately in the forward and backward directions and operated under desired conditions respectively, they can agitate the treatment material in an optimum manner appropriated for a particular mode of the processing action.

The treatment material agitating and processing apparatus allows the treatment material to be agitated by the rotation in the forward direction of the extruding agitator for continuous extrusion forming or quantitative extrusion action.

### INDUSTRIAL APPLICABILITY

As set forth above, the treatment material agitating and processing apparatus equipped with the features of the present invention including the construction and rotating action of the agitator(s) can significantly be improved in the operating efficiency, the consistency of processing action, the setting of processing durations, and the versatility to various materials to be agitated and utilized in a variety of the industries. In particular, the treatment material agitating and processing apparatus of the present invention will be suited for treating industrial wastes, liquifying biomass, processing food materials, and reactive processing or compounding polymer/chemical materials.

What is claimed is:

1. A treatment material agitating and processing apparatus comprising:
a casing having a supply inlet and a delivery outlet provided therein for input and output of a treatment material;
one or more agitators, each agitator consisting mainly of an agitator shaft and an agitating blade provided on the outer surface of the agitator shaft and arranged to extend lengthwise in the casing; and
a driving mechanism for driving the agitators to rotate in the casing, wherein the agitators repeat a given pattern of their forward and backward rotating actions thus to agitate and convey the treatment material throughout the casing.

2. A treatment material agitating and processing apparatus according to claim 1, wherein the agitators repeat the rotation alternately in the forward and backward directions.

3. A treatment material agitating and processing apparatus according to claim 1 or 2, wherein the agitators are automatically controlled for switching between the forward rotation and the backward rotation and determining the duration of the rotating action.

4. A treatment material agitating and processing apparatus according to any of claims 1 to 3, wherein the duration Ts of the agitators pausing between the forward rotation and the backward rotation is expressed by:
0≦Ts<t+2 (1)
where Ts is the duration of the agitators pausing between the forward rotation and the backward rotation and t is the length of time from the cancellation of the action of the driving mechanism to the pause of the agitators.

5. A treatment material agitating and processing apparatus according to any of claims 1 to 4, wherein the duration Tf of the agitators rotating in the forward direction is expressed by:
0<Tf<0.2×(60p)/(Nk) (2)
where Tf is the duration of the agitators rotating in the forward direction, p is the number of pitches on the agitating blade of the agitator, N is the rotating speed of the agitator, and k is a coefficient (0<k≦1).

6. A treatment material agitating and processing apparatus according to any of claims 1 to 5, wherein the duration Tr of the agitators rotating in the backward direction is expressed by:
0<Tr<Tmin (3)
Tmax<Tr<Tf (4)
where Tr is the duration of the agitators rotating in the backward direction, Tf is the duration of the agitators rotating in the forward direction, and Tmin and Tmax are the small value and the large value of the solutions Tr at
kN(Ts+Tr)(Tf/Tr)/{30p(Tf+Tr+2Ts)}=0.1

7. A treatment material agitating and processing apparatus according to any of claims 1 to 6, wherein the agitators are axially provided in a row with the agitator shaft of one agitator extending lengthwise through the agitator shaft of its neighbor agitator at the upstream side and driven separately by the irrespective driving mechanisms, at least one of the agitators arranged for repeatedly rotating alternately in the forward and backward directions in a given pattern thus to agitate and convey the treatment material throughout the casing.

8. A treatment material agitating and processing apparatus according to any of claims 1 to 7, further comprising an extruding agitator provided between the delivery outlet of the casing and the free end of the agitators for rotating constantly in the forward direction.
